(19) United States
(12) Patent Application Publication
(10) Pub. No.: US 2015/0361297 A1
(43) Pub. Date: Dec. 17, 2015

(54) POWDER COATING MATERIAL SET, AND POWDER COATING MATERIAL COMPOSITION

(71) Applicant: FUJI XEROX CO., LTD., TOKYO (JP)

(72) Inventors: Masato MIKAMI, Kanagawa (JP); Makoto FURUKI, Kanagawa (JP); Satoshi YOSHIDA, Kanagawa (JP)

(21) Appl. No.: 14/525,706

(22) Filed: Oct. 28, 2014

(30) Foreign Application Priority Data
Jun. 12, 2014 (JP) 2014-121627

(51) Int. Cl. C09D 167/03

(52) U.S. Cl. CPC C09D 167/03

(57) ABSTRACT

A powder coating material set for performing color matching by dry mixing of at least two kinds of powder coating materials having different colors is disclosed. The powder coating materials contain powder particles, and the powder particles contain a thermosetting resin and a thermosetting agent, and have a volume average particle diameter of 3 μm to 10 μm and a GSDv of equal to or smaller than 1.3.

### CROSS-REFERENCE TO RELATED APPLICATIONS

This application is based on and claims priority under 35 USC 119 from Japanese Patent Application No. 2014-121627 filed Jun. 12, 2014.

### BACKGROUND

1. Technical Field

The present invention relates to a powder coating material set and a powder coating material composition.

2. Related Art

In recent years, since a small amount of volatile organic compounds (VOC) is discharged in a coating step and a powder coating material which is not attached to a material to be coated may be collected and reused after the coating, a powder coating technology using a powder coating material is given attention from the viewpoint of a global environment. Accordingly, various powder coating materials are being investigated.

### SUMMARY

According to an aspect of the invention, there is provided a powder coating material set for performing color matching by dry mixing of at least two kinds of powder coating materials having different colors,

wherein the powder coating materials contain powder particles, and

wherein the powder particles contain a thermosetting resin and a thermosetting agent, and have a volume average particle diameter of 3 μm to 10 μm and a GSDv of equal to or smaller than 1.3.

### DETAILED DESCRIPTION

Hereinafter, exemplary embodiment of a toning method, a powder coating material composition, and a powder coating material set of the present invention will be described in detail.

Toning Method

A toning method according to the exemplary embodiment including: performing color matching by dry mixing of at least two kinds of powder coating materials having different colors, in which the powder coating materials contain powder particles, the powder particles contain a thermosetting resin and a thermosetting agent, a volume average particle diameter thereof is from 3 μm to 10 μm, and GSDv thereof is equal to or smaller than 1.3.

The powder coating material used in the toning method according to the exemplary embodiment may be any of a transparent powder coating material (clear coating material) not containing a colorant in the powder particles, and a colored powder coating material containing a colorant in the powder particles.

The colors of the powder coating material used in the toning method according to the exemplary embodiment are not particularly limited. For example, in a case of using the powder coating materials with two colors, a combination of a cyan color and a magenta color, a combination of a cyan color and a yellow color, a combination of a magenta color and a yellow color, or the like is used. In a case of using the powder coating materials with three colors, a combination of a cyan color, a magenta color, and a yellow color, or the like is used. The transparent powder coating material may be further combined with respect to these combinations. A white powder coating material, a black powder coating material, or the like may be further combined.

In general, when the powder coating materials having different colors are mixed and coated on a material to be coated by an electrostatic coating gun or the like, and the powder coating material is burned, the non-uniform color of the coating film may be visually observed. In the related art, in some cases, an uneven hue is generated on a surface of a coating film depending on a hue and/or a tone of two or more kinds of the powder coating material to be mixed, and it is difficult to obtain a coating film having uniform hue and tone. Accordingly, it is necessary to prepare a powder coating material for realizing a color for each required color, and the number of the materials is excessively increased. Therefore, it is desired to develop a method of combining the limited number of colored (primary colored) powder coating materials to tone to a wide range of colors.

As a result of the investigation, the inventors have found that, in a case of performing color matching by dry mixing of the powder coating materials, when the powder particles contain a thermosetting resin and a thermosetting agent, a volume average particle diameter thereof is from 3 μm to 10 μm, and a GSDv thereof is equal to or smaller than 1.3, a mottled appearance is reduced and an excellent toning property is obtained.

As a result, it is possible to perform toning to a wide range of colors with the fewer kinds of the powder coating materials than in the related art.

The toning method according to the exemplary embodiment may be used in a manufacturing method of a powder coating material composition according to the exemplary embodiment.

Hereinafter, the powder coating material used in the exemplary embodiment will be described in detail.

The powder coating material used in the exemplary embodiment contains the powder particles. The powder coating material may contain an external additive, if necessary, in order to improve fluidity.

Powder Particles

A structure of the powder particles contained in the powder coating material used in the exemplary embodiment is not particularly limited. The powder particles preferably have a structure including a core and a resin coating portion for coating a surface of the core, in order to prevent exposure of a pigment which may be contained in the powder particles and will be described later, to the surface of the powder particles. That is, the powder particles preferably have a core/shell structure.

By causing the pigment not to be exposed to the surface of the powder particles, a difference in a charge amount between the particles with different colors is decreased, a blending variation at the time of coating is decreased, and therefore an excellent toning property is obtained.

Property of Powder Particles

A volume average particle size distribution index GSDv of the powder particles is equal to or smaller than 1.3, preferably equal to or smaller than 1.28, and more preferably equal to or smaller than 1.25, from viewpoints of charge stability of the powder particles, smoothness of a coating film, and coating stability when reusing collected powder particles.

A volume average particle diameter D50v of the powder particles is from 3 Inn to 10 preferably from 4 μm to 10 μm, more preferably from 4 μm to 8 μm, and even more preferably from 5 μm to 7 μm, from viewpoints of a decrease of uneven hue on a surface of a coating film of two or more kinds of the powder coating materials to be mixed, formation of a coating film having high smoothness with a small amount of the coating materials, and transportability in a coating device.

An average circularity of the powder particles is preferably equal to or greater than 0.96, and more preferably equal to or greater than 0.97, from the viewpoints of smoothness of the coating film and fluidity of the powder coating material.

Herein, the volume average particle diameter D50v and the volume average particle size distribution index GSDv of the powder particles are measured with a Coulter Multisizer II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% by weight aqueous solution of surfactant (preferably sodium alkylbenzene sulfonate) as a dispersing agent. The obtained material is added to 100 ml to 150 ml of the electrolyte.

The electrolyte in which the sample is suspended is subjected to a dispersion treatment using an ultrasonic disperser for 1 minute, and a particle size distribution of particles having a particle diameter of 2 μm to 60 μm is measured by a Coulter Multisizer II using an aperture having an aperture diameter of 100 μm. 50,000 particles are sampled.

Cumulative distributions by volume are drawn from the side of the smallest diameter with respect to particle size ranges (channels) separated based on the measured particle size distribution. The particle diameter when the cumulative percentage becomes 16% is defined as that corresponding to a volume particle diameter D16v, while the particle diameter when the cumulative percentage becomes 50% is defined as that corresponding to a volume average particle diameter D50v. Furthermore, the particle diameter when the cumulative percentage becomes 84% is defined as that corresponding to a volume particle diameter D84v.

A volume average particle size distribution index (GSDv) is calculated as (D84v/D16v)^{1/2}.

The average circularity of the powder particles is measured by using a flow type particle image analyzer “FPIA-3000 (manufactured by Sysmex Corporation) ”. Specifically, 0.1 ml to 0.5 ml of a surfactant (alkyl benzene sulfonate) as a dispersant is added into 100 ml to 150 ml of water obtained by removing impurities which are solid matter in advance, and 0.1 g to 0.5 g of a measurement sample is further added thereto. A suspension in which the measurement sample is dispersed is subjected to a dispersion process with an ultrasonic dispersion device for 1 minute to 3 minutes, and concentration of the dispersion is from 3,000 particles/μl to 10,000 particles/μl. Regarding this dispersion, the average circularity of the powder particles is measured by using the flow type particle image analyzer.

Herein, the average circularity of the powder particles is a value obtained by acquiring a circularity (Ci) of each of n particles measured for the powder particles and then performing calculation with the following equation. However, in the following equation, Ci represents a circularity (=circumference length of a circle equivalent to a projected area of the particle/circumference length of a particle projection image), and fi represents frequency of the powder particles.

$$Average circularity ( Ca ) = ( {\sum }_{i = 1}^{n} ( Ci \times fi ) ) / {\sum }_{i = 1}^{n} ( fi ) \qquad Expression 1$$

Core

The powder particles contained in the powder coating material used in the exemplary embodiment contain a thermosetting resin and a thermosetting agent. When the powder particles have a structure including the core and the resin coating portion for coating the surface of the core, the core may contain the thermosetting resin and the thermosetting agent. The core may contain other additives such as a colorant, if necessary.

Thermosetting Resin

The thermosetting resin is a resin including a thermosetting reaction group. In the related art, as the thermosetting resin, various types of resin used in the powder particles of the powder coating material are used.

The thermosetting resin may preferably be a water-insoluble (hydrophobic) resin. When the water-insoluble (hydrophobic) resin is used as the thermosetting resin, environmental dependence of a charging property of the powder coating material (powder particle) is decreased. When preparing the powder particle by an aggregation and coalescence method, the thermosetting resin is preferably a water-insoluble (hydrophobic) resin, in order to realize emulsification and dispersion in an aqueous medium. The water-insolubility (hydrophobicity) means that a dissolved amount of a target material is less than 5 parts by weight with respect to 100 parts by weight of water at 25° C.

Among the thermosetting resins, at least one kind selected from the group consisting of a thermosetting (meth)acrylic resin and a thermosetting polyester resin is preferable. In the exemplary embodiment, (meth)acryl means acryl or methacryl, and a (meth)acryloyl group means an acryloyl group or a methacryloyl group.

Thermosetting (Meth)Acrylic Resin

The thermosetting (meth)acrylic resin is a (meth)acrylic resin including a thermosetting reaction group. For the introduction of the thermosetting reaction group to the thermosetting (meth)acrylic resin, a vinyl monomer including a thermosetting reaction group may be preferably used. The vinyl monomer including a thermosetting reaction group may be a (meth)acrylic monomer (monomer having a (meth)acryloyl group), or may be a vinyl monomer other than the (meth)acrylic monomer.

Examples of the thermosetting reaction group of the thermosetting (meth)acrylic resin include an epoxy group, a carboxyl group, a hydroxyl group, an amide group, an amino group, an acid anhydride group, a (block) isocyanate group, and the like. Among these, as the thermosetting reaction group of the (meth)acrylic resin, at least one kind selected from the group consisting of an epoxy group, a carboxyl group, and a hydroxyl group is preferable, from the viewpoint of ease of preparation of the (meth)acrylic resin. Particularly, from the viewpoints of excellent storage stability of the powder coating material and coating film appearance, at least one kind of the thermosetting reaction group is more preferably an epoxy group.

Examples of the vinyl monomer including an epoxy resin as the thermosetting reaction group include various chain epoxy group-containing monomers (for example, glycidyl(meth)acrylate, β-methyl glycidyl(meth)acrylate, glycidyl vinyl ether, and allyl glycidyl ether), various (2-oxo-1,3-oxolane) group-containing vinyl monomers (for example, (2-oxo-1,3-oxolane) methyl(meth)acrylate), various alicyclic epoxy group-containing vinyl monomers (for example, 3,4-epoxycyclohexyl(meth)acrylate, 3,4-epoxycyclohexylmethyl(meth)acrylate, and 3,4-epoxycyclohexylethyl(meth)acrylate), and the like.

Examples of the vinyl monomer including a carboxyl group as the thermosetting reaction group include various carboxyl group-containing monomers (for example, (meth)acrylic acid, crotonic acid, itaconic acid, maleic acid, and fumaric acid), various monoesters of α,β-unsaturated dicarboxylic acid and monohydric alcohol having 1 to 18 carbon atoms (for example, monomethyl fumarate, monoethyl fumarate, monobutyl fumarate, monoisobutyl fumarate, monotert-butyl fumarate, monohexyl fumarate, monooctyl fumarate, mono 2-ethylhexyl fumarate, monomethyl maleate, monoethyl maleate, monobutyl maleate, monoisobutyl maleate, monotert-butyl maleate, monohexyl maleate, monooctyl maleate, and mono 2-ethylhexyl maleate), monoalkyl ester itaconate (for example, monomethyl itaconate, monoethyl itaconate, monobutyl itaconate, monoisobutyl itaconate, monohexyl itaconate, monooctyl itaconate, and mono 2-ethylhexyl itaconate), and the like.

Examples of the vinyl monomer including a hydroxyl group as the thermosetting reaction group include various hydroxyl group-containing (meth)acrylates (for example, 2-hydroxyethyl(meth)acrylate, 2-hydroxypropyl(meth)acrylate, 3-hydroxypropyl(meth)acrylate, 2-hydroxybutyl(meth)acrylate, 3-hydroxybutyl(meth)acrylate, 4-hydroxybutyl(meth)acrylate, polyethylene glycol mono(meth)acrylate, and polypropylene glycol mono(meth)acrylate), an addition reaction product of the various hydroxyl group-containing (meth)acrylates and ε-caprolactone, various hydroxyl group-containing vinyl ethers (for example, 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, and 6-hydroxyhexyl vinyl ether), an addition reaction product of the various hydroxyl group-containing vinyl ethers and ε-caprolactone, various hydroxyl group-containing allyl ethers (for example, 2-hydroxyethyl(meth)allyl ether, 3-hydroxypropyl(meth)allyl ether, 2-hydroxypropyl (meth)allyl ether, 4-hydroxybutyl(meth)allyl ether, 3-hydroxybutyl(meth)allyl ether, 2-hydroxy-2-methylpropyl(meth)allyl ether, 5-hydroxypentyl(meth)allyl ether, and 6-hydroxyhexyl(meth)allyl ether), an addition reaction product of the various hydroxyl group-containing allyl ethers and ε-caprolactone, and the like.

In the thermosetting(meth)acrylic resin, other vinyl monomer not including a thermosetting reaction group may be copolymerized, in addition to the (meth)acrylic monomer.

Examples of the other vinyl monomer include various α-olefins (for example, ethylene, propylene, and butene-1), various halogenated olefins except fluoroolefin (for example, vinyl chloride and vinylidene chloride), various aromatic vinyl monomers (for example, styrene, α-methyl styrene, and vinyl toluene), various diesters of unsaturated dicarboxylic acid and monohydric alcohol having 1 to 18 carbon atoms (for example, dimethyl fumarate, diethyl fumarate, dibutyl fumarate, dioctyl fumarate, dimethyl maleate, diethyl maleate, dibutyl maleate, dioctyl maleate, dimethyl itaconate, diethyl itaconate, dibutyl itaconate, and dioctyl itaconate), various acid anhydride group-containing monomers (for example, maleic anhydride, itaconic anhydride, citraconic anhydride, (meth)acrylic anhydride, and tetrahydrophthalic anhydride), various phosphoric acid ester group-containing monomers (for example, diethyl-2-(meth)acryloyloxyethyl phosphate, dibutyl-2-(meth)acryloyloxybutyl phosphate, dioctyl-2-(meth)acryloyloxyethyl phosphate, and diphenyl-2-(meth)acryloyloxyethyl phosphate), various hydrolyzable silyl group-containing monomers (for example, γ-(meth)acryloyloxypropyl trimethoxysilane, γ-(meth)acryloyloxypropyl triethoxysilane, and γ-(meth)acryloyloxypropyl methyldimethoxysilane), variuos vinyl aliphatic carboxylate (for example, vinyl acetate, vinyl propionate, vinyl butyrate, vinyl isobutyrate, vinyl caproate, vinyl caprylate, caprate, vinyl laurate, branched vinyl aliphatic carboxylate having 9 to 11 carbon atoms, and vinyl stearate), various vinyl ester of carboxylic acid having a cyclic structure (for example, vinyl cyclohexane carboxylate, vinyl methylcyclohexane carboxylate, vinyl benzoate, and p-tert-butyl vinyl benzoate), and the like.

In the thermosetting (meth)acrylic resin, in the case of using a vinyl monomer other than the (meth)acrylic monomer, as the vinyl monomer including a thermosetting reaction group, a (meth)acrylic monomer not including a thermosetting reaction group is used.

Examples of the (meth)acrylic monomer not including a thermosetting reaction group include alkyl ester(meth)acrylate (for example, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-hexyl(meth)acrylate, cyclohexyl(meth)acrylate, 2-ethylhexyl(meth)acrylate, n-octyl(meth)acrylate, isooctyl(meth)acrylate, 2-ethyloctyl(meth)acrylate, dodecyl(meth)acrylate, isodecyl(meth)acrylate, lauryl(meth)acrylate, and stearyl(meth)acrylate), various arylester(meth)acrylates (for example, benzyl(meth)acrylate, phenyl(meth)acrylate, and phenoxyethyl(meth)acrylate), various alkyl carbitol(meth)acrylates (for example, ethyl carbitol(meth)acrylate), other various ester(meth)acrylates (for example, isobornyl(meth)acrylate, dicyclopentanyl(meth)acrylate, dicyclopentonyl(meth)acrylate, dicyclopentenyloxyethyl(meth)acrylate, and tetrahydrofurfuryl(meth)acrylate), various amino group-containing amide unsaturated monomers (for example, N-dimethylaminoethyl(meth)acrylamide, N-diethylaminoethyl(meth)acrylamide, N-dimethylaminopropyl(meth)acrylamide, and N-diethylaminopropyl(meth)acrylamide), various dialkylaminoalkyl(meth)acrylates (for example, dimethylaminoethyl(meth)acrylate and diethylaminoethyl(meth)acrylate), various amino group-containing monomers (for example, tert-butylaminoethyl(meth)acrylate, tert-butylaminopropyl(meth)acrylate, aziridinylethyl(meth)acrylate, pyrrolidinylethyl(meth)acrylate, and piperidinylethyl(meth)acrylate), and the like.

The thermosetting(meth)acrylic resin is preferably a (meth)acrylic resin of which a number average molecular weight is from 1,000 to 20,000 (more preferably from 1,500 to 15,000).

When the number average molecular weight thereof is in the range described above, smoothness and mechanical properties of the coating film are easily improved.

The number average molecular weight of the thermosetting (meth)acrylic resin is measured by gel permeation chromatography (GPC). The molecular weight measurement by GPC is performed with a THF solvent using HLC-8120 GPC, which is GPC manufactured by Tosoh Corporation as a measurement device and TSKge1 Super HM-M (15 cm), which is a column manufactured by Tosoh Corporation. The weight average molecular weight and the number average molecular weight are calculated using a calibration curve of molecular weight created with a monodisperse polystyrene standard sample from results of this measurement.

Thermosetting Polyester Resin

The thermosetting polyester resin is, for example, a polycondensate obtained by polycondensing at least polybasic acid and polyol. The introduction of the thermosetting reaction group to the thermosetting polyester resin is performed by adjusting amounts of polybasic acid and polyol used. With this adjustment, a thermosetting polyester resin including at least one of a carboxyl group and a hydroxyl group as a thermosetting reaction group is obtained.

Examples of polybasic acid include terephthalic acid, isophthalic acid, phthalic acid, methylterephthalic acid, trimellitic acid, pyromellitic acid, or anhydrides thereof; succinic acid, adipic acid, azelaic acid, sebacic acid, or anhydrides thereof; maleic acid, itaconic acid, or anhydrides thereof; fumaric acid, tetrahydrophthalic acid, methyltetrahydrophthalic acid, hexahydrophthalic acid, methylhexahydrophthalic acid, or anhydrides thereof; cyclohexane dicarboxylic acid, 2,6-naphthalene dicarboxylic acid, and the like.

Examples of polyol include ethylene glycol, diethylene glycol, propylene glycol, dipropylene glycol, 1,3-butanediol, 1,4-butanediol, 1,5-pentanediol, 1,6-hexanediol, neopentyl glycol, triethylene glycol, bis-hydroxyethyl terephthalate, cyclohexanedimethanol, octanediol, diethylpropane diol, butylethylpropane diol, 2-methyl-1,3-propane diol, 2,2,4-trimethylpentane diol, hydrogenated bisphenol A, an ethylene oxide adduct of hydrogenated bisphenol A, an propylene oxide adduct of hydrogenated bisphenol A, trimethylolethane, trimethylolpropane, glycerin, pentaerythritol, tris-hydroxyethyl isocyanurate, hydroxy pivalyl hydroxy pivalate, and the like.

The thermosetting polyester resin may be obtained by polycondensing other monomer in addition to polybasic acid and polyol.

Examples of the other monomer include a compound including both a carboxyl group and a hydroxyl group in one molecule (for example, dimethanol propionic acid and hydroxy pivalate), a monoepoxy compound (for example, glycidyl ester of branched aliphatic carboxylic acid such as “Cardura E10 (manufactured by Shell)”), various monohydric alcohols (for example, methanol, propanol, butanol, and benzyl alcohol), various monobasic acids (for example, benzoic acid and p-tert-butyl benzoate), various fatty acids (for example, castor oil fatty acid, coconut oil fatty acid, and soybean oil fatty acid), and the like.

The structure of the thermosetting polyester resin may be a branched structure or a linear structure.

Regarding the thermosetting polyester resin, the total of an acid value and a hydroxyl value is preferably from 10 mgKOH/g to 250 mgKOH/g, and the number average molecular weight is preferably from 1,000 to 100,000.

When the total of an acid value and a hydroxyl value is in the range described above, smoothness and a mechanical property of the coating film are easily improved. When the number average molecular weight is in the range described above, smoothness and a mechanical property of the coating film are improved and storage stability of the powder coating material is easily improved.

The measurement of the acid value and the hydroxyl value of the thermosetting polyester resin is performed based on JIS K-0070-1992. In addition, the measurement of the number average molecular weight of the thermosetting polyester resin is performed in the same manner as measurement of the number average molecular weight of the thermosetting (meth)acrylic resin.

The thermosetting resin may be used alone or in combination of two or more kinds thereof.

The content of the thermosetting resin is preferably 20% by weight to 99% by weight, and more preferably from 30% by weight to 95% by weight, with respect to the entirety of the powder particles.

In the case of using the thermosetting resin as the resin of the resin coating portion, the content of the thermosetting resin means the content of the entire thermosetting resin in the core and the resin coating portion.

Thermosetting Agent

The thermosetting agent is selected depending on the kinds of the thermosetting reaction group of the thermosetting resin.

When the thermosetting reaction group of the thermosetting resin is an epoxy group, specific examples of the thermosetting agent include acid such as succinic acid, glutaric acid, adipic acid, pimelic acid, suberic acid, azelaic acid, sebacic acid, dodecanedioic acid, eicosanoic diacid, maleic acid, citraconic acid, itaconic acid, glutaconic acid, phthalic acid, tetrahydrophthalic acid, hexahydrophthalic acid, cyclohexene-1,2-dicarboxylic acid, trimellitic acid, and pyromellitic acid; anhydrides thereof; urethane-modified products thereof; and the like. Among these, as the thermosetting agent, aliphatic dibasic acid is preferable from the viewpoints of a property of the coating film and storage stability, and dodecanedioic acid is particularly preferable from the viewpoint of a property of the coating film.

When the thermosetting reaction group of the thermosetting resin is a carboxyl group, specific examples of the thermosetting agent include various epoxy resins (for example, polyglycidylether of bisphenol A), an epoxy group-containing acrylic resin (for example, glycidyl group-containing acrylic resin), various polyglycidylethers of polyol (for example, 1,6-hexanediol, trimethylolpropane, and trimethylolethane), various polyglycidylesters of polycarboxylic acid (for example, phthalic acid, terephthalic acid, isophthalic acid, hexahydrophthalic acid, methyl hexahydrophthalic acid, trimellitic acid, and pyromellitic acid), various alicyclic epoxy group-containing compounds (for example, bis(3,4-epoxy cyclohexyl)methyl adipate), hydroxy amide (for example, triglycidylisocyanurate and β-hydroxyalkyl amide), and the like.

When the thermosetting reaction group of the thermosetting resin is a hydroxyl group, examples of the thermosetting agent include blocked polyisocyanate, aminoplast, and the like. Examples of blocked polyisocyanate include organic diisocyanate such as various aliphatic diisocyanates (for example, hexamethylene diisocyanate and trimethyl hexamethylene diisocyanate), various alicyclic diisocyanates (for example, xylylene diisocyanate and isophorone diisocyanate), various aromatic diisocyanates (for example, tolylene diisocyanate and 4,4′-diphenylmethane diisocyanate); an adduct of the organic diisocyanate and polyol, a low-molecular weight polyester resin (for example, polyester polyol), or water; a polymer of the organic diisocyanate (a polymer including isocyanurate-type polyisocyanate compound); various polyisocyanate compounds blocked by a commonly used blocking agent such as isocyanate biuret product; a self-block polyisocyanate compound having a uretdione bond as a structural unit; and the like.

The thermosetting agent may be used alone or in combination of two or more kinds thereof.

The content of the thermosetting agent is preferably from 1% by weight to 30% by weight and more preferably from 3% by weight to 20% by weight, with respect to the thermosetting resin.

When the thermosetting resin is used as the resin of the resin coating portion, the content of the thermosetting agent means a content with respect to the entire thermosetting resin in the core and the resin coating portion.

Colorant

As a colorant, a pigment is used, for example. As the colorant, a pigment and a dye may be used in combination.

Examples of a pigment include an inorganic pigment such as iron oxide (for example, colcothar), titanium oxide, titanium yellow, zinc white, white lead, zinc sulfide, lithopone, antimony oxide, cobalt blue, and carbon black; an organic pigment such as quinacridone red, phthalocyanine blue, phthalocyanine green, permanent red, Hansa yellow, indanthrene Blue, Brilliant Fast Scarlet, and benzimidazolone yellow; and the like.

In addition, as the pigment, a brilliant pigment is also used. Examples of the brilliant pigment include metal powder such as a pearl pigment, aluminum powder, stainless steel powder; metallic flakes; glass beads; glass flakes; mica; and flake-shaped iron oxide (MIO).

The colorant may be used alone or in combination of two or more kinds thereof.

The content of the colorant is determined depending on types of the pigment, and the hue, brightness, and the depth recquired for the coating film. The content of the colorant is, for example, preferably from 1% by weight to 70% by weight and more preferably from 2% by weight to 60% by weight, with respect to the entire resin in the core and the resin coating portion.

Other Additive

As the other additive, various additives used in the powder coating material are used. Specific examples of the other additive include a surface adjusting agent (silicone oil or acrylic oligomer), a foam inhibitor (for example, benzoin or benzoin derivatives), a hardening accelerator (an amine compound, an imidazole compound, or a cationic polymerization catalyst), a plasticizer, a charge-controlling agent, an antioxidant, a pigment dispersant, a flame retardant, a fluidity-imparting agent, and the like.

Resin Coating Portion

The resin coating portion includes a resin. The resin coating portion may be configured only of a resin, or may include other additives (the thermosetting agent described regarding the core, or other additives). However, the resin coating portion is preferably configured only of a resin, in order to further reduce the bleeding of the powder particles. Even when the resin coating portion includes the other additives, the content of the resin is preferably equal to or greater than 90% by weight (more preferably equal to or greater than 95% by weight) with respect to the entire resin coating portion.

The resin of the resin coating portion may be a non-curable resin, or maybe a thermosetting resin. However, the resin of the resin coating portion is preferably a thermosetting resin, in order to improve curing density (crosslinking density) of the coating film. When the thermosetting resin is used as the resin of the resin coating portion, as this thermosetting resin, the same thermosetting resin used for the thermosetting resin of the core is used. Particularly, when the thermosetting resin is used as the resin of the resin coating portion, the thermosetting resin is preferably at least one kind selected from the group consisting of a thermosetting (meth)acrylic resin and a thermosetting polyester resin. However, the thermosetting resin of the resin coating portion may be the same kind of resin as the thermosetting resin of the core or may be a different resin.

When the non-curable resin is used as the resin of the resin coating portion, the non-curable resin is preferably at least one kind selected from the group consisting of a (meth)acrylic resin and a polyester resin.

A coverage of the resin coating portion is preferably from 30% to 100% and more preferably from 50% to 100%, in order to prevent bleeding.

The coverage of the resin coating portion with respect to the surface of the powder particle is a value obtained by X-ray photoelectron spectroscopy (XPS) measurement.

Specifically, in the XPS measurement, JPS-9000MX manufactured by JEOL Ltd. is used as a measurement device, and the measurement is performed using a MgKα ray as the X-ray source and setting an accelerating voltage to 10 kV and an emission current to 30 mA. However, a device and conditions for the measurement are not limited thereto.

The coverage of the resin coating portion with respect to the surface of the powder particles is quantized by peak separation of a component derived from the material of the core and a component derived from a material of the resin coating portion on the surface of the powder particles, from the spectrum obtained under the conditions described above. In the peak separation, the measured spectrum is separated into each component using curve fitted by the least square method.

As the component spectrum to be a separation base, the spectrum obtained by singly measuring the thermosetting resin, a thermosetting agent, a pigment, an additive, a coating resin used in preparation of the powder particle is used. In addition, the coverage is obtained from a ratio of a spectral intensity derived from the coating resin with respect to the total of entire spectral intensity obtained from the powder particles.

A thickness of the resin coating portion is preferably from 0.2 μm to 4 μm and more preferably from 0.3 μm to 3 μm, in order to prevent bleeding.

The thickness of the resin coating portion is a value obtained by the following method.

The powder particle is embedded in the epoxy resin, and a sliced piece is prepared by performing cutting with a diamond knife or the like. This sliced piece is observed using a transmission electron microscope (TEM) or the like and plural images of the cross section of the powder particles are imaged. The thicknesses of 20 portions of the resin coating portion are measured from the images of the cross section of the powder particle, and an average value thereof is used. When it is difficult to observe the resin coating portion in the image of the cross section due to a clear powder coating material, it is possible to easily perform the measurement by performing dyeing and observation.

Other Component of Powder Particle

The powder particle preferably contains di- or higher-valent metal ions (hereinafter, simply referred to as “metal ions”). The metal ions are components contained in both of the core and the resin coating portion when the powder particle has a structure including the core and the resin coating portion for coating the surface of the core. When di- or higher-valent metal ions are contained in the powder particle, ion crosslinking is formed in the powder particle by the metal ions. For example, when the polyester resin is used as the thermosetting resin of the core and the resin of the resin coating portion, a carboxyl group or a hydroxyl group of the polyester resin interacts with the metal ions and the ion crosslinking is formed. With this ion crosslinking, the bleeding of the powder particles is prevented, and the storage property is easily improved. In addition, after coating with the powder coating material, the bond of the ion crosslinking is broken due to heating at the time of thermal curing, and accordingly, the melt viscosity of the powder particle decreases and a coating film having high smoothness is easily formed.

Examples of the metal ions include divalent to quadrivalent metal ions. Specifically, as the metal ions, at least one kind of metal ion selected from the group consisting of aluminum ions, magnesium ions, iron ions, zinc ions, and calcium ions is used.

As a supply source of the metal ion (compound added to the powder particle as an additive), metal salt, an inorganic metal salt polymer, a metal complex, and the like are used, for example. For example, when preparing the powder particle by an aggregation and coalescence method, the metal salt and the inorganic metal salt polymer are added to the powder particle as an aggregating agent.

Examples of the metal salt include aluminum sulfate, aluminum chloride, magnesium chloride, magnesium sulfate, ferrous chloride (II), zinc chloride, calcium chloride, calcium sulfate, and the like.

Examples of the inorganic metal salt polymer include polyaluminum chloride, polyaluminum hydroxide, iron polysulfate (II), calcium polysulfide, and the like.

Examples of the metal complex include metal salt of an aminocarboxylic acid and the like. Specific examples of the metal complex include metal salt (for example, calcium salt, magnesium salt, iron salt, and aluminum salt) using a well known chelate as a base such as ethylenediamine tetraacetic acid, propanediamine tetraacetic acid, nitrilotriacetic acid, triethylenetetramine hexaacetic acid, diethylenetriamine pentaacetic acid, and the like.

Such a supply source of the metal ions may not be added for use as an aggregating agent, but may be added simply as an additive.

As the valence of the metal ions is high, mesh ion crosslinking is easily formed, and it is preferable from the viewpoints of smoothness of the coating film and the storage properties of the powder coating material. Accordingly, the metal ions are preferably Al ions. That is, the supply source of the metal ions is preferably aluminum salt (for example, aluminum sulfate or aluminum chloride), or an aluminum salt polymer (for example, polyaluminum chloride or polyaluminum hydroxide). Among the supply sources of the metal ions, the inorganic metal salt polymer is preferable, compared to the metal salt, even when the valences of the metal ions thereof are the same as each other, from the viewpoints of smoothness of the coating film and the storage properties of the powder coating material. Accordingly, the supply source of the metal ions is particularly preferably an aluminum salt polymer (for example, polyaluminum chloride or polyaluminum hydroxide).

The content of the metal ions is preferably 0.002% by weight to 0.2% by weight and more preferably from 0.005% by weight to 0.15% by weight, with respect to the entire powder particle, from the viewpoints of smoothness of the coating film and the storage properties of the powder coating material.

When the content of the metal ions is equal to or greater than 0.002% by weight, suitable ion crosslinking is formed by the metal ions, bleeding of the powder particles is prevented, and the storage properties of the powder coating material are easily improved. Meanwhile, when the content of the metal ions is equal to or smaller than 0.2% by weight, the formation of excessive ion crosslinking by the metal ions is prevented, and the smoothness of the coating film is easily improved.

Herein, when preparing the powder particles by an aggregation and coalescence method, the supply source of the metal ions added as an aggregating agent (metal salt or metal salt polymer) contributes to controlling the particle size distribution and shapes of the powder particles.

Specifically, higher valence of the metal ions is preferable, in order to obtain a narrower particle size distribution. In addition, in order to obtain a narrow particle size distribution, the metal salt polymer is preferable, compared to the metal salt, even though the valences of the metal ions thereof are the same as each other. Accordingly, from the viewpoints described above, the supply source of the metal ions is preferably aluminum salt (for example, aluminum sulfate or aluminum chloride) and an aluminum salt polymer (for example, polyaluminum chloride or polyaluminum hydroxide), and particularly preferably an aluminum salt polymer (for example, polyaluminum chloride or polyaluminum hydroxide).

When the aggregating agent is added so that the content of the metal ions is equal to or greater than 0.002% by weight, aggregation of the resin particles in the aqueous medium proceeds, and this contributes to realization of the narrow particle size distribution. The aggregation of the resin particles to be the resin coating portion proceeds with respect to the aggregated particles to be the core, and this contributes to realization of the formation of the resin coating portion with respect to the entire surface of the core. Meanwhile, when the aggregating agent is added so that the content of the metal ions is equal to or smaller than 0.2% by weight, excessive ion crosslinking in the aggregated particles is prevented, and the shape of the powder particles generated when performing coalescence is easily set to be close to a sphere. Accordingly, from the viewpoints described above, the content of the metal ions is preferably from 0.002% by weight to 0.2% by weight and more preferably from 0.005% by weight to 0.15% by weight.

The content of the metal ions is measured by quantitative analysis of fluorescent X-ray intensity of the powder particles. Specifically, for example, first, the resin and the supply source of the metal ions are mixed with each other, and a resin mixture having a known concentration of the metal ions is obtained. A pellet sample is obtained with 200 mg of this resin mixture by using a tableting tool having a diameter of 13 mm. This pellet sample is precisely weighed, and the fluorescent X-ray intensity of the pellet sample is measured, to obtain peak intensity. In the same manner as described above, the measurement is performed for the pellet sample obtained by changing the added amount of the supply source of the metal ions, and a calibration curve is created with the results. The quantitative analysis of the content of the metal ions in the powder particle to be a measurement target is performed by using this calibration curve.

Examples of an adjusting method of the content of the metal ions include 1) a method of adjusting the added amount of the supply source of the metal ions, 2) a method of adjusting the content of the metal ions including, in a case of preparing the powder particles by an aggregation and coalescence method, adding the aggregating agent (for example, metal salt or the metal salt polymer) as the supply source of the metal ions in an aggregation step, adding a chelating agent (for example, ethylenediamine tetraacetic acid (EDTA), diethylenetriamine pentaacetic acid (DTPA), or nitrilotriacetic acid (NTA)) at a last stage of the aggregation step, forming a complex with the metal ions by the chelating agent, and removing the formed complex salt in a washing step or the like.

External Additive

An external additive prevents occurrence of aggregation between the powder particles. Accordingly, it is possible to form a coating film having high smoothness with a small amount thereof. Specific examples of the external additive include inorganic particles. Examples of the inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

A volume average particle diameter of the external additive is preferably from 10 nm to 40 nm and more preferably from 10 nm to 30 nm. When the external additive having the volume average particle diameter from 10 nm to 40 nm is used, when applying the powder coating material with a spray gun or the like, the powder particles are dispersed due to air flow and easily fly as primary particles, and the powder particles are attached to a material to be coated in a state of the primary particles so as to arrange (tone) the color in a unit of the particle diameter, and therefore an excellent toning property is obtained.

Surfaces of the inorganic particles as an external additive are preferably subjected to a hydrophobizing treatment. The hydrophobizing treatment is performed by, for example, dipping the inorganic particles in a hydrophobizing agent. The hydrophobizing agent is not particularly limited and examples thereof include a silano coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

The amount of the external additive externally added is, for example, preferably from 0.01% by weight to 5% by weight and more preferably from 0.01% by weight to 2.0% by weight, with respect to the powder particles.

Manufacturing Method of Powder Coating Material

Next, a manufacturing method of the powder coating material according to the exemplary embodiment will be described.

The powder coating material according to the exemplary embodiment is obtained by manufacturing the powder particles, and then externally adding the external additives to the powder particles, if necessary.

The powder particles may be manufactured using any of a dry manufacturing method (e.g., kneading and pulverizing method) and a wet manufacturing method (e.g., aggregation and coalescence method, suspension and polymerization method, and dissolution and suspension method). The powder particle manufacturing method is not particularly limited to these manufacturing methods, and a known manufacturing method is employed.

Among these, the powder particles are preferably obtained by an aggregation and coalescence method, in order to easily control the volume average particle size distribution index GSDv and the volume average particle size to be in the range described above.

Specifically, the powder particles are preferably manufactured by performing: a step of forming first aggregated particles by aggregating first resin particles and a thermosetting agent in a dispersion in which the first resin particles containing a thermosetting resin, and the thermosetting agent are dispersed, or by aggregating composite particles in a dispersion in which composite particles containing a thermosetting resin and a thermosetting agent are dispersed; a step of forming second aggregated particles in which the second resin particles are attached to the surface of the first aggregated particles by mixing a first aggregated particle dispersion in which the first aggregated particles are dispersed and a second resin particle dispersion in which second resin particles containing the resin are dispersed, with each other, aggregating the second resin particles on the surface of the first aggregated particles; and a step of heating a second aggregated particle dispersion in which the second aggregated particles are dispersed to coalesce the second aggregated particles.

In the powder particle manufactured by this aggregation and coalescence method, a portion where the first aggregated particles are coalesced is the core, and a portion where the second resin particles attached to the surface of the first aggregated particles are coalesced is the resin coating portion.

Hereinafter, the respective steps will be described in detail.

In the following description, a manufacturing method of powder particles containing a colorant will be described, but the colorant is only used if necessary.

Dispersion Preparation Step

First, each dispersion used in the aggregation and coalescence method is prepared. Specifically, a first resin particle dispersion in which first resin particles containing the thermosetting resin of the core are dispersed, a thermosetting agent dispersion in which the thermosetting agent is dispersed, a colorant dispersion in which the colorant is dispersed, and a second resin particle dispersion in which second resin particles containing the resin of the resin coating portion are dispersed, are prepared.

In addition, a composite particle dispersion in which the composite particles containing the thermosetting resin of the core and the thermosetting agent are dispersed is prepared, instead of the first resin particle dispersion and the thermosetting agent dispersion in which the thermosetting agent is dispersed.

In the dispersion preparation step, the first resin particles, the second resin particles, and the composite particles are collectively described as the “resin particles”.

Herein, a resin particle dispersion is, for example, prepared by dispersing the resin particles in a dispersion medium with a surfactant.

An aqueous medium is used, for example, as the dispersion medium used in the resin particle dispersion.

Examples of the aqueous medium include water such as distilled water, ion exchange water, or the like, alcohols, and the like. The medium may be used alone or in combination of two or more kinds thereof.

Examples of the surfactant include anionic surfactants such as sulfuric ester salt-based, sulfonate-based, phosphate ester-based, and soap-based anionic surfactants; cationic surfactants such as amine salt-based and quaternary ammonium salt-based cationic surfactants; and nonionic surfactants such as polyethylene glycol-based, alkyl phenol ethylene oxide adduct-based, and polyol-based nonionic surfactants. Among these, anionic surfactants and cationic surfactants are particularly used. Nonionic surfactants may be used in combination with anionic surfactants or cationic surfactants.

The surfactants may be used alone or in combination of two or more kinds thereof.

Regarding the resin particle dispersion, as a method of dispersing the resin particles in the dispersion medium, a common dispersing method using, for example, a rotary shearing-type homogenizer, or a ball mill, a sand mill, or a Dyno mill having media is exemplified. Depending on the kind of the resin particles, the resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding abase to an organic continuous phase (O phase); and converting the resin (so-called phase inversion) from W/O to O/W by adding an aqueous medium (W phase) to form a discontinuous phase, thereby dispersing the resin as particles in the aqueous medium.

As the manufacturing method of the resin particle dispersion, specifically, for example, in the case of manufacturing a (meth)acrylic resin particle dispersion, a raw material monomer is emulsified in an aqueous medium, and a water-soluble initiator, and if necessary, a chain transfer agent for controlling molecular weight are added thereto and the obtained mixture is heated to perform emulsification and polymerization, and accordingly resin particle dispersion in which the (meth)acrylic resin particles are dispersed is obtained.

In the case of manufacturing polyester resin particle dispersion, after performing heating, melting, and polycondensing under reduced pressure with respect to a raw material monomer, a solvent (for example, ethyl acetate) is added to the obtained polycondensation product for dissolution thereof, and the obtained solution is stirred while adding a weak alkaline aqueous solution thereto, and subjected to phase inversion emulsification, and accordingly, a resin particle dispersion in which the polyester resin particles are dispersed is obtained.

In addition, in the case of obtaining the composite particle dispersion, the resin and the thermosetting agent are mixed with each other, and are dispersed (for example, subjected to emulsification such as phase inversion emulsification) in a dispersion medium, and accordingly the composite particle dispersion is obtained.

The volume average particle diameter of the resin particles dispersed in the resin particle dispersion is, for example, preferably equal to or smaller than 1 μm, more preferably from 0.01 μm to 1 μm, even more preferably from 0.08 gm to 0.8 μm, and still more preferably from 0.1 μm, to 0.6 μm.

Regarding the volume average particle diameter of the resin particles, a cumulative distribution by volume is drawn from the side of the smallest diameter with respect to particle size ranges (channels) separated using the particle size distribution obtained by the measurement with a laser diffraction-type particle size distribution measuring device (for example, LA-700 manufactured by Horiba, Ltd.), and a particle diameter when the cumulative percentage becomes 50% with respect to the entire particles is measured as a volume average particle diameter D50v. The volume average particle diameter of the particles in other dispersions is also measured in the same manner.

The content of the resin particles contained in the resin particle dispersion is, for example, preferably from 5% by weight to 50% by weight, and more preferably from 10% by weight to 40% by weight.

For example, the thermosetting agent dispersion, and the colorant dispersion are also prepared in the same manner as in the case of the resin particle dispersion. That is, the resin particles in the resin particle dispersion are the same as the particles of the colorant dispersed in the colorant dispersion, and the particles of the thermosetting agent dispersed in the thermosetting agent dispersion, in terms of the volume average particle diameter, the dispersion medium, the dispersing method, and the content of the particles.

First Aggregated Particle Forming Step Next, the first resin particle dispersion, the thermosetting agent dispersion, and the colorant dispersion are mixed with each other.

The first resin particles, the thermosetting agent, and the colorant are heterogeneously aggregated in the mixed dispersion, thereby forming first aggregated particles having a diameter near a target powder particle diameter and including the first resin particles, the thermosetting agent, and the colorant.

Specifically, for example, an aggregating agent is added to the mixed dispersion and a pH of the mixed dispersion is adjusted to be acidic (for example, the pH is from 2 to 5). If necessary, a dispersion stabilizer is added. Then, the mixed dispersion is heated at a temperature of a glass transition temperature of the first resin particles (specifically, for example, from a temperature 30° C. lower than the glass transition temperature of the first resin particles to a temperature 10° C. lower than the glass transition temperature thereof) to aggregate the particles dispersed in the mixed dispersion, thereby forming the first aggregated particles.

In the first aggregated particle forming step, the first aggregated particles may be formed by mixing the composite particle dispersion including the thermosetting resin and the thermosetting agent, and the colorant dispersion with each other and heterogeneously aggregating the composite particles and the colorant in the mixed dispersion.

In the first aggregated particle forming step, for example, the aggregating agent may be added at room temperature (for example, 25° C.) while stirring the mixed dispersion using a rotary shearing-type homogenizer, the pH of the mixed dispersion may be adjusted to be acidic (for example, the pH is from 2 to 5), a dispersion stabilizer may be added if necessary, and the heating may then be performed.

Examples of the aggregating agent include a surfactant having an opposite polarity to the polarity of the surfactant used as the dispersing agent to be added to the mixed dispersion, metal salt, a metal salt polymer, and a metal complex. When a metal complex is used as the aggregating agent, the amount of the surfactant used is reduced and charging characteristics are improved.

After completing the aggregation, an additive for forming a complex or a similar bond with metal ions of the aggregating agent may be used, if necessary. A chelating agent is suitably used as this additive. With the addition of this chelating agent, the content of the metal ions of the powder particles may be adjusted, when the aggregating agent is excessively added.

Herein, the metal salt, the metal salt polymer, or the metal complex as the aggregating agent is used as a supply source of the metal ions. Examples thereof are as described above.

A water-soluble chelating agent is used as the chelating agent. Specific examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably from 0.01 parts by weight to 5.0 parts by weight, and more preferably from 0.1 parts by weight to less than 3.0 parts by weight with respect to 100 parts by weight of the resin particles.

Second Aggregated Particle Forming Step

Next, the obtained first aggregated particle dispersion in which the first aggregated particles are dispersed is mixed together with the second resin particle dispersion.

The second resin particles may be the same kind as the first resin particles or may be a different kind therefrom.

By performing aggregation such that the second resin particles are attached to the surface of the first aggregated particles in the mixed dispersion in which the first aggregated particles and the second resin particles are dispersed, thereby forming second aggregated particles in which the second resin particles are attached to the surface of the first aggregated particles.

Specifically, in the first aggregated particle forming step, for example, when the particle diameter of the first aggregated particles reaches a target particle diameter, the second resin particle dispersion is mixed with the first aggregated particle dispersion, and the mixed dispersion is heated at a temperature equal to or lower than the glass transition temperature of the second resin particles.

pH of the mixed dispersion is set to be in a range of 6.5 to 8.5, for example, and thereby the progress of the aggregation is stopped.

Accordingly, the second aggregated particles in which aggregation is performed such that the second resin particles are attached to the surface of the first aggregated particles are obtained.

Coalescence Step

Next, the second aggregated particle dispersion in which the second aggregated particles are dispersed is heated at, for example, a temperature that is equal to or higher than the glass transition temperature of the first and second resin particles (for example, a temperature that is higher than the glass transition temperature of the first and second resin particles by 10° C. to 30° C.) to coalesce the second aggregated particles and form the powder particles.

The powder particles are obtained through the foregoing steps.

Herein, after the coalescence step ends, the powder particles formed in the dispersion are subjected to a washing step, a solid-liquid separation step, and a drying step, that are well known, and thus dry powder particles are obtained.

In the washing step, preferably displacement washing using ion exchange water is sufficiently performed from the viewpoint of charging properties. In addition, the solid-liquid separation step is not particularly limited, but suction filtration, pressure filtration, or the like is preferably performed from the viewpoint of productivity. The method for the drying step is also not particularly limited, but freeze drying, airflow drying, fluidized drying, vibration-type fluidized drying, or the like is preferably performed from the viewpoint of productivity.

The powder coating material according to the exemplary embodiment is manufactured by adding and mixing, for example, an external additive to the obtained dry powder particles, if necessary. The mixing is preferably performed with, for example, a V-blender, a Henschel mixer, a Lodige mixer, or the like. Furthermore, if necessary, coarse particles of the powder coating material may be removed using a vibration sieving machine, a wind-classifier, or the like.

In the toning method according to the exemplary embodiment, when at least two kinds of powder coating materials with different colors from each other are dry-mixed, a ratio (B/A) of a volume average particle diameter A of the powder particle having the maximum volume average particle diameter and a volume average particle diameter B of the powder particle having the minimum volume average particle diameter among the powder particles contained in the powder coating material, is preferably equal to or greater than 0.3, more preferably equal to or greater than 0.4, and even more preferably equal to or greater than 0.5. When the ratio (B/A) is equal to or greater than 0.3, the mottled appearance is further reduced and a more excellent toning property is obtained.

In the exemplary embodiment, examples of a device for performing dry mixing of the powder coating material include a V-blender, a Henschel mixer, a Lodige mixer, and the like.

Powder Coating Material Composition

The powder coating material composition according to the exemplary embodiment contains at least two kinds of powder particles with different colors from each other, the powder particles contain a thermosetting resin and a thermosetting agent, a volume average particle diameter thereof is from 3 to 10 and a GSDv thereof is equal to or smaller than 1.3.

The powder coating material composition according to the exemplary embodiment may be manufactured by the toning method according to the exemplary embodiment.

The powder coating material composition according to the exemplary embodiment may contain at least two kinds of powder particles with different colors from each other, and may contain an external additive or the like, if necessary.

As powder particles used in the powder coating material composition according to the exemplary embodiment, the powder particles used in the toning method according to the exemplary embodiment are used.

In the powder coating material composition according to the exemplary embodiment, the amount of the external additive externally added is, for example, preferably from 0.01% by weight to 5% by weight and more preferably from 0.01% by weight to 2.0% by weight, with respect to the total of the entirety of the powder particles contained in the powder coating material composition according to the exemplary embodiment. As the external additive used in the powder coating material composition according to the exemplary embodiment, the external additive disclosed in the description of the toning method according to the exemplary embodiment is used. As a method for externally adding the external additive, the external adding method disclosed in the description of the toning method according to the exemplary embodiment is used.

The colors of the powder particles contained in the powder coating material composition according to the exemplary embodiment are not particularly limited. For example, in a case of using the powder particles with two colors, a combination of a cyan color and a magenta color, a combination of a cyan color and a yellow color, a combination of a magenta color and a yellow color, or the like is used. In a case of using the powder particles with three colors, a combination of a cyan color, a magenta color, and a yellow color, or the like is used. The transparent powder particles maybe further combined with respect to these combinations. A white powder coating material, a black powder coating material, or the like may be further combined with the combinations.

Powder Coating Material Set

The powder coating material set according to the exemplary embodiment contains at least two kinds of powder coating materials with different colors from each other, the powder coating materials contain powder particles, the powder particles contain a thermosetting resin and a thermosetting agent, a volume average particle diameter thereof is from 3 μm to 10 μm, and a GSDv thereof is equal to or smaller than 1.3.

As the powder coating materials used in the powder coating material set according to the exemplary embodiment, the powder coating materials used in the toning method according to the exemplary embodiment are used.

The colors of the powder coating materials used in the powder coating material set according to the exemplary embodiment are not particularly limited. For example, in a case of using the powder coating materials with two colors, a combination of a cyan color and a magenta color, a combination of a cyan color and a yellow color, a combination of a magenta color and a yellow color, or the like is used. In a case of using the powder coating materials with three colors, a combination of a cyan color, a magenta color, and a yellow color, or the like is used. The transparent powder coating material may be further combined with respect to these combinations. A white powder coating material, a black powder coating material, or the like may be further combined with the combinations.

Coated Article/Manufacturing Method of Coated Article

The coated article according to the exemplary embodiment may be a coated article which is coated with the powder coating materials toned by the toning method according to the exemplary embodiment, may be a coated article which is coated with the powder coating material composition according to the exemplary embodiment as the powder coating material, or may be a coated article which is coated with the mixed powder coating material toned by using each powder coating material contained in the powder coating material set according to the exemplary embodiment.

As a manufacturing method of the coated article according to the exemplary embodiment, there is a manufacturing method of the coated article which includes performing coating with the powder coating materials toned by the toning method according to the exemplary embodiment, with the powder coating material composition according to the exemplary embodiment, or with the mixed powder coating material toned by using each powder coating material contained in the powder coating material set according to the exemplary embodiment.

In detail, after coating a surface to be coated with the powder coating material or the powder coating material composition, a coating film having the powder coating material or the powder coating material composition cured by heating (burning) is formed, and accordingly the coated article is obtained. The coating and the heating (burning) of the powder coating material or the powder coating material composition may be performed all together.

In the coating of the powder coating material or the powder coating material composition, a well-known coating method such as electrostatic powder coating, frictional charge powder coating, or fluidized dipping is used. A thickness of the coating film of the powder coating material or the powder coating material composition is, for example, preferably from 10 μm to 100 Rm.

A heating temperature (burning temperature) is, for example, preferably from 90° C. to 250° C., more preferably from 100° C. to 220° C., and even more preferably from 120° C. to 200° C. The heating time (burning time) is adjusted depending on the heating temperature (burning temperature).

A target product to be coated with the powder coating material or the powder coating material composition is not particularly limited, and various metal components, ceramic components, or resin components are used. These target products may be products which are not yet molded to the products such as a plate-shaped product or a linear product, and may be molded products which are molded to be used in an electronic component, a road vehicle, or an interior and exterior material of a building. In addition, the target product may be a product including a surface to be coated which is subjected to a surface treatment such as a primer treatment, a plating treatment, or an electrodeposition coating, in advance.

### EXAMPLES

Hereinafter, the exemplary embodiment will be described in detail using examples, but is not limited to these examples.

Preparation of Thermosetting Polyester Resin 1 Raw materials having the following composition are put into a reaction vessel including a stirrer, a thermometer, a nitrogen gas introducing tube, and a rectifier, heated to 240° C. while stirring under a nitrogen atmosphere, and subjected to a polycondensation reaction.
Terephthalic acid: 742 parts by weight (100 mol %)
Neopentyl glycol: 312 parts by weight (62 mol %)
Ethylene glycol: 59.4 parts by weight (20 mol %)
Glycerin: 90 parts by weight (18 mol %)
di-n-butyl tin oxide: 0.5 part by weight

Regarding the obtained thermosetting polyester resin 1, the glass transition temperature is 55° C., the acid value (Av) is 8 mgKOH/g, the hydroxyl value (OHv) is 70 mgKOH/g, the weight average molecular weight is 26,000, and the number average molecular weight is 8,000.

Preparation of Composite Particle Dispersion 1 While maintaining a 3-liter jacketed reaction vessel (BJ-30N manufactured by Tokyo Rikakikai Co., Ltd.) including a capacitor, a thermometer, a water dropping device, and an anchor blade in a water circulating constant temperature vessel at 40° C., a mixed solvent of 180 parts by weight of ethyl acetate and 80 parts by weight of isopropyl alcohol is put in the reaction vessel, and the following composition is added thereto.
Thermosetting polyester resin 1: 240 parts by weight
Blocked isocyanate curing agent VESTAGON B1530 (manufactured by Evonik Industries): 60 parts by weight
Benzoin: 3 parts by weight
Acrylic oligomer (Acronal 4F manufactured by BASF): 3 parts by weight

Next, after adding the composition, the mixture is stirred by using a three-one motor at 150 rpm and is dissolved to obtain an oil phase mixture. A mixed solution of 1 part by weight of 10% by weight ammonia aqueous solution and 47 parts by weight of 5% by weight aqueous sodium hydroxide is added dropwise to the oil phase mixture being stirred for 5 minutes and mixed therewith for 10 minutes, and 900 parts by weight of ion exchange water is further added dropwise to the mixture at a rate of 5 parts by weight per minute to perform phase inversion, and an emulsified solution is obtained.

800 parts by weight of the obtained emulsified solution and 700 parts by weight of ion exchange water are put into a 2-liter eggplant flask, and set in an evaporator (manufactured by Tokyo Rikakikai Co., Ltd.) including a vacuum control unit through a trap bump. The mixture is heated in a hot bath at 60° C. while rotating the eggplant flask, the pressure is reduced to 7 kPa while paying attention to bumping, and the solvent is removed. The pressure is returned to the normal pressure when the solvent collection amount becomes 1,100 parts by weight, the eggplant flask is water-cooled, and dispersion is obtained. The obtained dispersion does not have the odor of the solvent. A volume average particle diameter of the composite particles containing the thermosetting polyester resin and the thermosetting agent in this dispersion is 150 nm.

After that, 2% by weight of an anionic surfactant (Dowfax2A1 manufactured by The Dow Chemical Company, 45% by weight of the active ingredients) is added to and mixed with respect to the resin in the dispersion, as an active ingredient, and the ion exchange water is added thereto to adjust the solid content concentration to 20% by weight. This is set as the composite resin particle dispersion 1 containing the thermosetting polyester resin and the thermosetting agent.

Preparation of Thermosetting Polyester Resin Particle Dispersion 2

Thermosetting polyester resin particle dispersion 2 is obtained under the same conditions as in preparation of the composite particle dispersion 1, except for setting the amount of the thermosetting polyester resin 1 to 300 parts by weight and not adding the blocked isocyanate curing agent, benzoin, and acrylic oligomer.

Preparation of Colorant Dispersion (C1)

Cyan pigment (C.I. Pigment Blue 15:3, (copper phthalocyanine) manufactured by Dainichiseika Color & Chemicals Mfg. Co., Ltd.): 100 parts by weight Anionic surfactant (NEOGEN RK manufactured by Dai-Ichi Kogyo Seiyaku Co., Ltd.): 15 parts by weight

Ion exchange water: 450 parts by weight

The above components are mixed with each other, and dispersed for 1 hour using a high pressure impact type dispersing machine ULTIMIZER (HJP30006 manufactured by Sugino Machine, Ltd.), and accordingly colorant dispersion in which the cyan pigment is dispersed is prepared. When performing measurement using a laser diffraction type particle size measuring device, a volume average particle diameter of the cyan pigment in the colorant dispersion is 0.13 μm and the solid content ratio in the colorant dispersion is 25% by weight.

Preparation of Colorant Dispersion (M1)

Colorant dispersion (M1) is prepared by the same method as that of the colorant dispersion (C1), except for changing the cyan pigment to a magenta pigment (quinacridone pigment: CHROMOFINE MAGENTA 6887 manufactured by Dainichiseika Color & Chemicals Mfg. Co., Ltd.). When performing measurement using a laser diffraction type particle size measuring device, a volume average particle diameter of the magenta pigment in the colorant dispersion is 0.14 μm and the solid content ratio in the colorant dispersion is 25% by weight.

Preparation of Colorant Dispersion (Y1)

Colorant dispersion (Y1) is prepared by the same method as that of the colorant dispersion (C1), except for changing the cyan pigment to a yellow pigment (Paliotol Yellow d1155 manufactured by BASF). When performing measurement using a laser diffraction type particle size measuring device, a volume average particle diameter of the yellow pigment in the colorant dispersion is 0.13 μm and the solid content ratio in the colorant dispersion is 25% by weight.

Preparation of Colorant Dispersion (K1)

Colorant dispersion (K1) is prepared by the same method as that of the colorant dispersion (C1), except for changing the cyan pigment to a black pigment (Regal 330 manufactured by Cabot Corporation). When performing measurement using a laser diffraction type particle size measuring device, a volume average particle diameter of the black pigment in the colorant dispersion is 0.11 μm and the solid content ratio in the colorant dispersion is 25% by weight.

Preparation of Colorant Dispersion (W1)
Titanium oxide (A-220 manufactured by Ishihara Sangyo Kaisha, Ltd.): 100 parts by weight
Anionic surfactant (NEOGEN RK manufactured by Dai-Ichi Kogyo Seiyaku Co., Ltd.): 15 parts by weight
Ion exchange water: 400 parts by weight

The above components are mixed with each other, and dispersed for 3 hours using a high pressure impact type dispersing machine ULTIMIZER (HJP30006 manufactured by Sugino Machine, Ltd.), and accordingly colorant dispersion in which titanium oxide is dispersed is prepared. When performing measurement using a laser diffraction type particle size measuring device, a volume average particle diameter of titanium oxide in the colorant dispersion is 0.25 μm and the solid content ratio in the colorant dispersion is 25% by weight .

Preparation of Cyan Particles 1

Aggregation Step
Composite particle dispersion 1: 325 parts by weight (solid content: 65 parts by weight)
Colorant dispersion (C1): 3 parts by weight (solid content: 0.75 part by weight)
Colorant dispersion (W1): 150 parts by weight (solid content: 37.5 parts by weight)

The above components are sufficiently mixed and dispersed in a round stainless steel flask using a homogenizer (ULTRA-TURRAX T50 manufactured by IKA Ltd.). Then, the pH is adjusted to 2.5 by using 1.0% by weight nitric acid aqueous solution. 0.50 part by weight of 10% by weight polyaluminum chloride aqueous solution is added thereto, and the dispersion operation is continued.

A stirrer and a mantle heater are installed, the temperature is increased to 50° C. while appropriately adjusting the rotation rate of the stirrer so that the slurry is sufficiently stirred, and the slurry is held for 15 minutes at 50° C. Then, when a volume average particle diameter of the aggregated particles is 5.5 μm, 100 parts by weight of thermosetting polyester resin particle dispersion 2 is slowly added thereto. Then, after adding 40 parts by weight of 10% by weight nitrilotriacetic acid (NTA) metal salt aqueous solution (Chelest 70 manufactured by Chelest Corporation), pH is adjusted to 6.0 by using 5% by weight aqueous sodium hydroxide.

Coalescence Step

The resultant material is held for 30 minutes, and then is heated to 85° C., and held for 1.5 hours. A nearly spheroidized state is observed with an optical microscope.

Filtration·Washing·Drying Step

After completing the reaction, the solution in the flask is cooled and filtered to obtain the solid content. Next, after washing this solid content with ion exchange water, solid-liquid separation is performed by Nutsche-type suction filtration, and the solid content is obtained again.

Next, this solid content is dispersed again in 3 liters of ion exchange water at 40° C., and stirred and washed at 300 rpm for 15minutes. This washing operation is repeated 5 times, and the solid content obtained by solid-liquid separation by Nutsche-type suction filtration is subjected to vacuum drying for 12 hours. Then, 0.5 parts by weight of hydrophobic silica particles (primary particle diameter of 16 nm) is added with respect to 100 parts by weight of solid content, and the powder coating material (cyan particles 1) containing the polyester resin is obtained.

Preparation of Cyan Particles 2

Cyan Particles 2 are obtained by the same method as in the preparation of the cyan particles 1, except for not using nitrilotriacetic acid metal salt aqueous solution, and setting the amount of 10% by weight polyaluminum chloride aqueous solution to 1.8 parts by weight.

Preparation of Cyan Particles 3

Cyan Particles 3 are obtained by the same method as in the preparation of the cyan particles 1, except for not using nitrilotriacetic acid metal salt aqueous solution, and setting the amount of 10% by weight polyaluminum chloride aqueous solution to 2.2 parts by weight.

Preparation of Cyan Particles 4

Cyan Particles 4 are obtained by the same method as in the preparation of the cyan particles 1, except for increasing the temperature to 85° C. in the coalescence step and setting the holding time to 1.2 hours.

Preparation of Cyan Particles 5

Cyan Particles 5 are obtained by the same method as in the preparation of the cyan particles 1, except for increasing the temperature to 32° C. and holding the material for 15 minutes at 32° C., instead of increasing the temperature to 50° C. and holding the material for 15 minutes at 50° C.

Preparation of Cyan Particles 6

Cyan Particles 6 are obtained by the same method as in the preparation of the cyan particles 5, except for not using nitrilotriacetic acid metal salt aqueous solution, and setting the amount of 10% by weight polyaluminum chloride aqueous solution to 1.8 parts by weight.

Preparation of Cyan Particles 7

Cyan Particles 7 are obtained by the same method as in the preparation of the cyan particles 5, except for not using nitrilotriacetic acid metal salt aqueous solution, and setting the amount of 10% by weight polyaluminum chloride aqueous solution to 2.2 parts by weight.

Preparation of Cyan Particles 8

Cyan Particles 8 are obtained by the same method as in the preparation of the cyan particles 5, except for increasing the temperature to 85° C. in the coalescence Step and setting the holding time to 1.2 hours.

Preparation of Cyan Particles 9

Cyan Particles 9 are obtained by the same method as in the preparation of the cyan particles 1, except for increasing the temperature to 30° C. and holding the material for 15 minutes at 30° C., instead of increasing the temperature to 50° C. and holding the material for 15 minutes at 50° C.

Preparation of Cyan Particles 10

Cyan Particles 10 are obtained by the same method as in the preparation of the cyan particles 1, except for increasing the temperature to 60° C. and holding the material for 25 minutes at 60° C., instead of increasing the temperature to 50° C. and holding the material for 15 minutes at 50° C.

Preparation of Cyan Particles 11

Cyan Particles 11 are obtained by the same method as in the preparation of the cyan particles 10, except for not using nitrilotriacetic acid metal salt aqueous solution, and setting the amount of 10% by weight polyaluminum chloride aqueous solution to 1.8 parts by weight.

Preparation of Cyan Particles 12

Cyan Particles 12 are obtained by the same method as in the preparation of the cyan particles 10, except for not using nitrilotriacetic acid metal salt aqueous solution, and setting the amount of 10% by weight polyaluminum chloride aqueous solution to 2.2 parts by weight.

Preparation of Cyan Particles 13

Cyan Particles 13 are obtained by the same method as in the preparation of the cyan particles 10, except for increasing the temperature to 85° C. in the coalescence Step and setting the holding time to 1.2 hours.

Preparation of Cyan Particles 14

Cyan Particles 14 are obtained by the same method as in the preparation of the cyan particles 1, except for increasing the temperature to 63° C. and holding the material for 15 minutes at 63° C., instead of increasing the temperature to 50° C. and holding the material for 15 minutes at 50° C.

Preparation of Magenta Particles 1

Magenta particles 1 are obtained by the same method as in the preparation of the cyan particles 1, except for using the colorant dispersion (M1) instead of the colorant dispersion (Cl).

Preparation of Yellow Particles 1

Yellow particles 1 are obtained by the same method as in the preparation of the cyan particles 1, except for using 5 parts by weight of the colorant dispersion (Y1) instead of the colorant dispersion (Cl).

Preparation of Black Particles 1

Black particles 1 are obtained by the same method as in the preparation of the cyan particles 1, except for using the colorant dispersion (K1) instead of the colorant dispersion (C1).

Preparation of White Particles 1

White particles 1 are obtained by the same method as in the preparation of the cyan particles 1, except for not adding the colorant dispersion (C1).

The properties of the cyan particles 1 to 14, the magenta particles 1, the yellow particles 1, the black particles 1, and the white particles 1 are shown in Table 1.

TABLE 1

| | Volume average | | |
|---|---|---|---|
| | particle | | Average |
| | diameter (μm) | GSDv | circularity |
| Cyan particles 1 | 5.6 | 1.22 | 0.97 |
| Cyan particles 2 | 5.6 | 1.28 | 0.97 |
| Cyan particles 3 | 5.6 | 1.32 | 0.97 |
| Cyan particles 4 | 5.6 | 1.21 | 0.95 |
| Cyan particles 5 | 3.2 | 1.22 | 0.97 |
| Cyan particles 6 | 3.2 | 1.28 | 0.97 |
| Cyan particles 7 | 3.2 | 1.33 | 0.97 |
| Cyan particles 8 | 3.2 | 1.21 | 0.95 |
| Cyan particles 9 | 2.8 | 1.22 | 0.97 |
| Cyan particles 10 | 9.8 | 1.21 | 0.97 |
| Cyan particles 11 | 9.8 | 1.28 | 0.97 |
| Cyan particles 12 | 9.8 | 1.32 | 0.97 |
| Cyan particles 13 | 9.8 | 1.22 | 0.95 |
| Cyan particles 14 | 10.2 | 1.21 | 0.97 |
| Magenta particles 1 | 5.6 | 1.22 | 0.97 |
| Yellow particles 1 | 5.6 | 1.23 | 0.97 |
| Black particles 1 | 5.6 | 1.21 | 0.97 |
| White particles 1 | 5.7 | 1.22 | 0.97 |

Evaluation

Preparation of Evaluation Sample

The powder coating material (composition) is coated on a cold rolled steel sheet subjected to a zinc phosphate treatment and having a thickness of 0.8 mm, by an electrostatic spray coating machine for the powder coating material, and burned at 180° C. for 20 minutes, and an evaluation plate with a cured coating film formed thereon is obtained.

The combination of the powder coating materials for configuring the powder coating material (composition) used in the evaluation is as follows. The equal amount of each powder coating material is mixed with each other, and a powder coating material (composition) for evaluation is obtained.

Evaluation of Mottled Appearance of Hue

Each of the obtained coating films is observed at a predetermined distance from the coating films, and the mottled appearance of the hues on the surface of the coating film is visually evaluated.

The evaluation criteria are as follows.

G5: Even when the coating film is observed closely, uniformity is recognized.

G4: When the coating film is observed at a distance of 0.25 m, uniformity is recognized.

G3: When the coating film is observed at a distance of 0.5 m, uniformity is recognized.

G2: When the coating film is observed at a distance of 1 m, uniformity is recognized.

G1: When the coating film is observed at a distance of 1 m, mottled appearance of hues is recognized.

This evaluation is performed by several people and an average value thereof is set as an evaluation result.

G3 and higher levels are set as the acceptable levels.

The particles used and the evaluation results are shown in Tables 2 to 5.

TABLE 2

| | Particles 1 | Particles 2 | Particles 3 | Grade |
|---|---|---|---|---|
| Example 1 | Cyan | Magenta | — | 4.9 |
| | particles 1 | particles 1 | | |
| Example 2 | Cyan | Yellow | — | 4.9 |
| | particles 1 | particles 1 | | |
| Example 3 | Cyan | Black | — | 4.9 |
| | particles 1 | particles 1 | | |
| Example 4 | Cyan | White | — | 4.8 |
| | particles 1 | particles 1 | | |
| Example 5 | Cyan | Magenta | White | 4.6 |
| | particles 1 | particles 1 | particles 1 | |
| Example 6 | Cyan | Yellow | White | 4.7 |
| | particles 1 | particles 1 | particles 1 | |
| Example 7 | Magenta | Yellow | White | 4.7 |
| | particles 1 | particles 1 | particles 1 | |
| Example 8 | Cyan | Magenta | — | 3.6 |
| | particles 2 | particles 1 | | |
| Example 9 | Cyan | Magenta | — | 4.5 |
| | particles 4 | particles 1 | | |
| Com. Ex. 1 | Cyan | Magenta | — | 2.8 |
| | particles 3 | particles 1 | | |
| Example 10 | Cyan | Yellow | — | 3.8 |
| | particles 2 | particles 1 | | |
| Example 11 | Cyan | Yellow | — | 4.6 |
| | particles 4 | particles 1 | | |
| Com. Ex. 2 | Cyan | Yellow | — | 2.8 |
| | particles 3 | particles 1 | | |
| Example 12 | Cyan | Black | — | 3.6 |
| | particles 2 | particles 1 | | |
| Example 13 | Cyan | Black | — | 4.5 |
| | particles 4 | particles 1 | | |
| Com. Ex. 3 | Cyan | Black | — | 2.8 |
| | particles 3 | particles 1 | | |
| Example 14 | Cyan | White | — | 3.5 |
| | particles 2 | particles 1 | | |
| Example 15 | Cyan | White | — | 4.4 |
| | particles 4 | particles 1 | | |
| Com. Ex. 4 | Cyan | White | — | 2.8 |
| | particles 3 | particles 1 | | |

TABLE 3

| | Particles 1 | Particles 2 | Particles 3 | Grade |
|---|---|---|---|---|
| Example 16 | Cyan | Magenta | — | 4.8 |
| | particles 5 | particles 1 | | |
| Example 17 | Cyan | Yellow | — | 4.8 |
| | particles 5 | particles 1 | | |
| Example 18 | Cyan | Black | — | 4.9 |
| | particles 5 | particles 1 | | |
| Example 19 | Cyan | White | — | 4.7 |
| | particles 5 | particles 1 | | |
| Example 20 | Cyan | Magenta | White | 4.4 |
| | particles 5 | particles 1 | particles 1 | |
| Example 21 | Cyan | Yellow | White | 4.3 |
| | particles 5 | particles 1 | particles 1 | |
| Example 22 | Cyan | Magenta | — | 3.5 |
| | particles 6 | particles 1 | | |
| Example 23 | Cyan | Magenta | — | 4.4 |
| | particles 8 | particles 1 | | |
| Com. Ex. 5 | Cyan | Magenta | — | 2.6 |
| | particles 7 | particles 1 | | |
| Example 24 | Cyan | Yellow | — | 4.4 |
| | particles 6 | particles 1 | | |
| Example 25 | Cyan | Yellow | — | 4.2 |
| | particles 8 | particles 1 | | |
| Com. Ex. 6 | Cyan | Yellow | — | 2.6 |
| | particles 7 | particles 1 | | |
| Example 26 | Cyan | Black | — | 3.6 |
| | particles 6 | particles 1 | | |
| Example 27 | Cyan | Black | — | 4.5 |
| | particles 8 | particles 1 | | |
| Com. Ex. 7 | Cyan | Black | — | 2.8 |
| | particles 7 | particles 1 | | |
| Example 28 | Cyan | White | — | 3.5 |
| | particles 6 | particles 1 | | |
| Example 29 | Cyan | White | — | 4.4 |
| | particles 8 | particles 1 | | |
| Com. Ex. 8 | Cyan | White | — | 2.8 |
| | particles 7 | particles 1 | | |

TABLE 4

| | Particles 1 | Particles 2 | Particles 3 | Grade |
|---|---|---|---|---|
| Example 30 | Cyan | Magenta | — | 4.8 |
| | particles 10 | particles 1 | | |
| Example 31 | Cyan | Yellow | — | 4.8 |
| | particles 10 | particles 1 | | |
| Example 32 | Cyan | Black | — | 4.9 |
| | particles 10 | particles 1 | | |
| Example 33 | Cyan | White | — | 4.7 |
| | particles 10 | particles 1 | | |
| Example 34 | Cyan | Magenta | White | 4.4 |
| | particles 10 | particles 1 | particles 1 | |
| Example 35 | Cyan | Yellow | White | 4.3 |
| | particles 10 | particles 1 | particles 1 | |
| Example 36 | Cyan | Magenta | — | 3.5 |
| | particles 11 | particles 1 | | |
| Example 37 | Cyan | Magenta | — | 4.4 |
| | particles 13 | particles 1 | | |
| Com. Ex. 9 | Cyan | Magenta | — | 2.6 |
| | particles 12 | particles 1 | | |
| Example 38 | Cyan | Yellow | — | 4.4 |
| | particles 11 | particles 1 | | |
| Example 39 | Cyan | Yellow | — | 4.2 |
| | particles 13 | particles 1 | | |
| Com. Ex. 10 | Cyan | Yellow | — | 2.6 |
| | particles 12 | particles 1 | | |
| Example 40 | Cyan | Black | — | 3.6 |
| | particles 11 | particles 1 | | |
| Example 41 | Cyan | Black | — | 4.5 |
| | particles 13 | particles 1 | | |
| Com. Ex. 11 | Cyan | Black | — | 2.8 |
| | particles 12 | particles 1 | | |
| Example 42 | Cyan | White | — | 3.5 |
| | particles 11 | particles 1 | | |
| Example 43 | Cyan | White | — | 4.4 |
| | particles 13 | particles 1 | | |
| Com. Ex. 12 | Cyan | White | — | 2.8 |
| | particles 12 | particles 1 | | |

TABLE 5

| | Particles 1 | Particles 2 | Particles 3 | Grade |
|---|---|---|---|---|
| Com. Ex. 13 | Cyan | Magenta | — | 1.8 |
| | particles 9 | particles 1 | | |
| Com. Ex. 14 | Cyan | Magenta | — | 1.8 |
| | particles 14 | particles 1 | | |

Excellent evaluation results are obtained regarding the mottled appearance of the hues of the powder coating material (composition) according to the examples. In contrast, bad evaluation results are obtained regarding the mottled appearance of the hues of the powder coating material (composition) according to the comparative examples.

The bad evaluation result regarding the mottled appearance of the hue of Comparative Example 13 is obtained. Since the portion of the coating film formed with the powder particles aggregated with each other is observed, the reason for this evaluation result is considered to be the aggregates.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A powder coating material set for performing color matching by dry mixing of at least two kinds of powder coating materials having different colors,
wherein the powder coating materials contain powder particles, and
wherein the powder particles contain a thermosetting resin and a thermosetting agent, and have a volume average particle diameter of 3 μm to 10 μm and a GSDv of equal to or smaller than 1.3.

2. The powder coating material set according to claim 1,
wherein an average circularity of the powder particles is equal to or greater than 0.96.

3. The powder coating material set according to claim 1,
wherein a ratio (B/A) of a volume average particle diameter A of the powder particle having the maximum volume average particle diameter and a volume average particle diameter B of the powder particle having the minimum volume average particle diameter among the powder particles, is equal to or greater than 0.3.

4. The powder coating material set according to claim 1,
wherein the powder particles includes a core containing the thermosetting resin and the thermosetting agent, and a resin coating portion for coating a surface of the core.

5. The powder coating material set according to claim 1,
wherein the powder coating materials contain an external additive having a volume average particle diameter of 10 nm to 40 nm.

6. The powder coating material set according to claim 1,
wherein the thermosetting resin is at least one kind selected from the group consisting of a thermosetting (meth)acrylic resin and a thermosetting polyester resin.

7. The powder coating material set according to claim 6,
wherein a number average molecular weight of the thermosetting (meth)acrylic resin is from 1,000 to 20,000.

8. The powder coating material set according to claim 6,
wherein the total of an acid value and a hydroxyl value of the thermosetting polyester resin is from 10 mgKOH/g to 250 mgKOH/g.

9. The powder coating material set according to claim 6,
wherein a number average molecular weight of the thermosetting polyester resin is from 1,000 to 100,000.

10. The powder coating material set according to claim 6,
wherein a content of the thermosetting agent is from 1% by weight to 30% by weight with respect to the thermosetting resin.

11. A powder coating material composition for performing color matching by dry mixing of at least two kinds of powder coating materials having different colors,
wherein the powder coating materials contain powder particles, and
wherein the powder particles contain a thermosetting resin and a thermosetting agent, and have a volume average particle diameter of 3 μm to 10 μm and a GSDv of equal to or smaller than 1.3.

12. The powder coating material composition according to claim 11,
wherein an average circularity of the powder particles is equal to or greater than 0.96.

13. The powder coating material composition according to claim 11,
wherein a ratio (B/A) of a volume average particle diameter A of the powder particle having the maximum volume average particle diameter and a volume average particle diameter B of the powder particle having the minimum volume average particle diameter among the powder particles, is equal to or greater than 0.3.

14. The powder coating material composition according to claim 11,
wherein the powder particles includes a core containing the thermosetting resin and the thermosetting agent, and a resin coating portion for coating a surface of the core.

15. The powder coating material composition according to claim 11,
wherein the powder particles contain an external additive having a volume average particle diameter of 10 nm to 40 nm.

16. The powder coating material composition according to claim 11,
wherein the thermosetting resin is at least one kind selected from the group consisting of a thermosetting (meth)acrylic resin and a thermosetting polyester resin.

17. The powder coating material composition according to claim 16,
wherein a number average molecular weight of the thermosetting (meth)acrylic resin is from 1,000 to 20,000.

18. The powder coating material composition according to claim 16,
wherein the total of an acid value and a hydroxyl value of the thermosetting polyester resin is from 10 mgKOH/g to 250 mgKOH/g.

19. The powder coating material composition according to claim 16,
wherein a number average molecular weight of the thermosetting polyester resin is from 1,000 to 100,000.

20. The powder coating material composition according to claim 16,
wherein a content of the thermosetting agent is from 1% by weight to 30% by weight with respect to the thermosetting resin.
